(19) United States
(12) Patent Application Publication
(10) Pub. No.: US 2020/0245588 A1
(43) Pub. Date: Aug. 6, 2020

(54) CAT LITTER BOX

(71) Applicant: James Daniel Hawks, Greenbrier, AR (US)

(72) Inventor: James Daniel Hawks, Greenbrier, AR (US)

(21) Appl. No.: 16/268,590

(22) Filed: Feb. 6, 2019

(51) Int. Cl. A01K 1/01; A01K 1/035

(52) U.S. Cl. CPC A01K 1/0107; A01K 1/035

(57) ABSTRACT

A litter box assembly configured to be covered and such that an animal using the litter box will be required to enter and exit along an access ramp with a perforated surface such that any excess litter or excrement stuck to the animal's paws falls through to be caught in a removable tray.

### BACKGROUND OF THE INVENTION

This invention relates to the field of feline litter boxes. More particularly, the present invention relates to a feline litter box designed to prevent cats from tracking litter out of the box with their feet.

Feline litter, commonly called cat litter or kitty litter, typically consists of granules of varying size from fine dust up to a few millimeters in size. When a cat uses a litter box to excrete waste, the cat will necessarily be standing in the litter. In doing so, the cat will often have little granules stick to its paws. When the cat exits the box, the granules which have stuck to the cat will be transferred out of the litter box and end up elsewhere as they fall off the cat. Commonly available cat litter boxes are either open at the top and sides or covered but with a large opening leading directly from the litter box to the outside. As a result, it is desirable to have a feline litter box which will remove litter from a cat's feet and body and collect it prior to the cat's exiting the box.

### SUMMARY OF THE INVENTION

The present invention is a feline litter box which has been designed to remove litter from a cat which has adhered to the animal while using the box. The removed litter is caught and stored in the box until it can be handled or disposed of by the owner.

The advantages of the present invention include, without limitation, that it is simple in manufacture, installation, and use, and provides a substantially cleaner and tidier litter facility for cats. The use of a litter box which forces a cat to exit the box through a designated route with perforations to dislodge excess litter and catch it in a pan below allows for the use of a litter box with substantially less tracking of litter by the cat into surrounding areas, which has benefits in both aesthetics and cleanliness of the surrounding areas.

### BRIEF DESCRIPTION OF THE DRAWINGS

FIG. 1 is an orthogonal, front view of the litter box;

FIG. 2 is an orthogonal, rear view of the litter box;

FIG. 3 is an orthogonal, top view of a portion of the litter box showing the litter tray and access ramp;

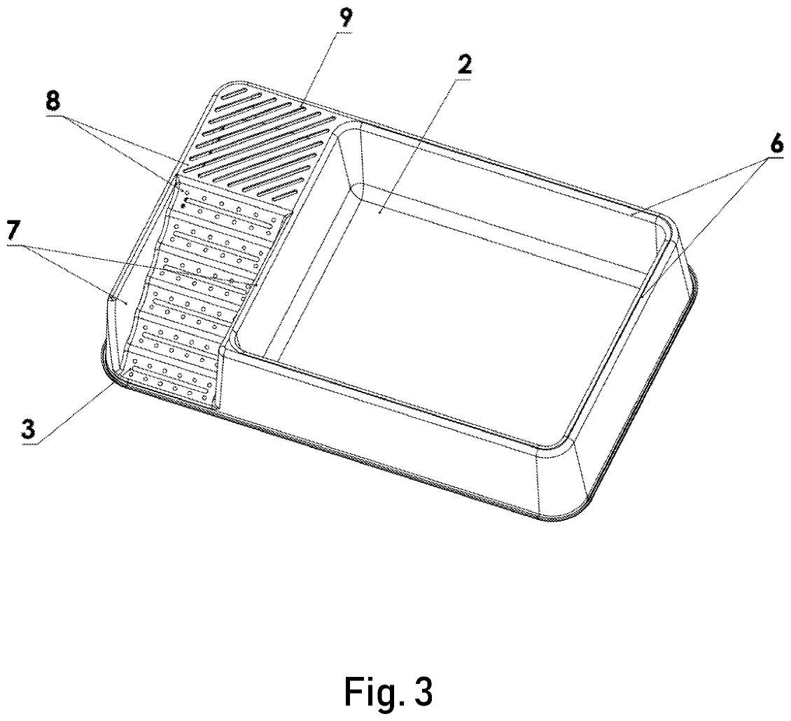

FIG. 4 is an orthogonal, top view of the catch tray;

FIG. 5 is an orthogonal, bottom view of the cover; and

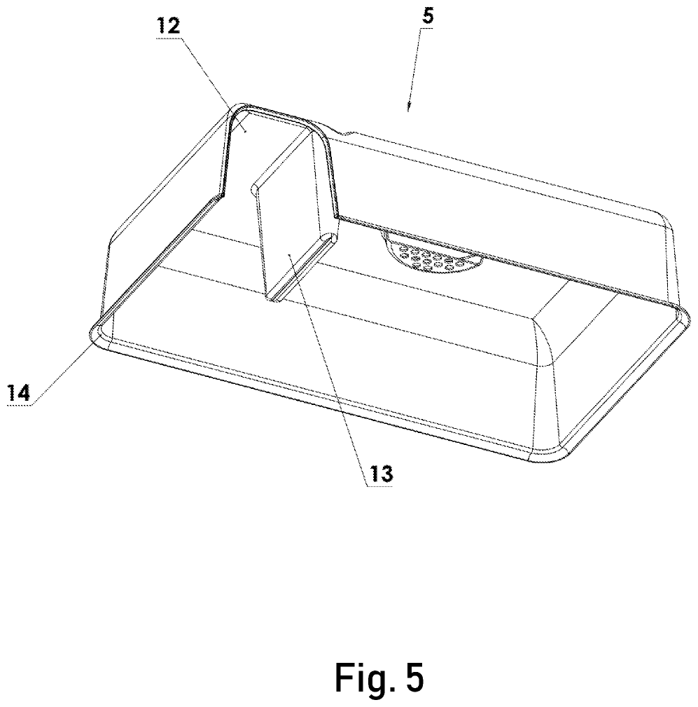

FIG. 6 is an exploded view showing all components of the litter box.

### DETAILED DESCRIPTION OF THE INVENTION

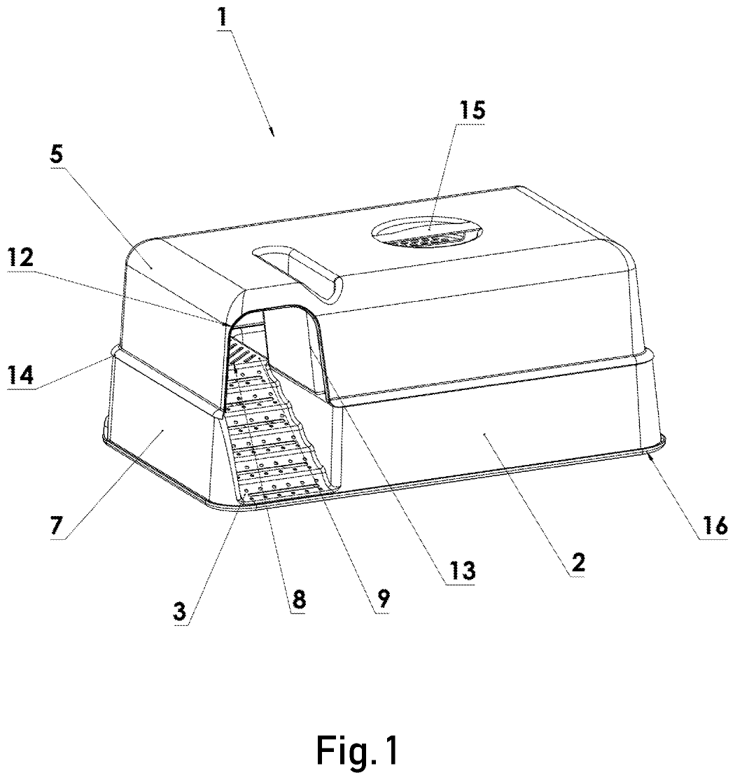

Referring to the drawings, FIGS. 1,2, and 6 depict a litter box assembly 1 featuring a litter tray 2, access ramp 3, catch tray 4, and cover 5. The litter box assembly is preferably made of rigid plastic, but may also be made of any other rigid or semi rigid, non-porous material or combination of multiple such materials.

The litter tray 2 is configured to hold cat litter which is placed into the tray as well as contain any excrement which is left in the tray by a cat using the litter box. The litter tray shall be a generally concave piece which is preferably rectangular in form, though it may take other shapes as well. The litter tray 2 has raised sides 6 which serve to contain the litter and excrement placed in the tray.

Proximate the litter tray 2 is the access ramp 3. The access ramp 3 is preferably single-piece in construction as well as affixed to or otherwise made one piece with the litter tray 2. However, the access ramp 3 may be constructed of multiple pieces and not affixed to the litter tray 2. The access ramp preferably takes the shape of an inclined plane or a stair-step orientation. The access ramp further consists or partitions 7 on either side of the ramp configured to force a using feline to travel down the ramp as opposed to traveling around it. The partition 7 on the side of the ramp which is proximate the litter tray 2 is preferably affixed to the raised side 6 of the tray or consists of a single piece with the raised side of the tray. However, the partition 7 adjacent to the litter tray may be a separate piece from and unaffixed to the raised side of the litter tray.

The surface of the access ramp 3 shall have perforations 8 which are configured allow debris to fall through. The surface of the access ramp 3 may have perforations over all or only a portion of the surface. The perforations 8 are preferably circular but may also take any other physical shape such as a slot, oval, ellipse, or polygonal shape. The perforations 8 are preferably sized such that an average domestic kitten's paw will not become entangled or pass through. The access ramp may also have an upper platform 9 at the uppermost portion of the ramp. The upper platform shall be adjacent to the raised side 6 of the litter tray 2 and is preferably flush with the uppermost part of the raised side 6 of the litter tray 2.

The access ramp 3 shall also have a tray opening 10 in the rear or side of the ramp 3 which allow access under the ramp for inserting and removing the catch tray 4. The tray opening 10 is preferably in the form of a slot which is substantially the same shape and dimension as the catch tray 4 such that the tray 4 will fit into the tray opening 10. However, the tray opening 10 may be substantially larger than the catch tray 4. The catch tray 4, which is placed under the access ramp 3, shall be a generally concave piece which is preferably rectangular in form, though it may take other shapes as well. The catch tray 4 has raised sides which serve to contain any litter and debris which falls through the access ramp 3. The catch tray 4 shall be shaped and dimensioned such that it fully underpins all portions of the access ramp 3 which are perforated. The catch tray 4 may also have a tab 11 configured such that it may be grasped by the human user of the litter box 1. The tab 11 shall be located on the side of the catch tray 4 which is proximate the tray opening 10 of the access ramp 3.

The litter box 1 shall also consist of a cover 5 which is sized and shaped to correspond with that of the combined litter tray 2 and access ramp 3. The cover is preferably configured such that it rests all sides on the litter tray and access ramp where two sides rests on adjacent of the raised sides 6 of the litter tray 2, one side rests on the outermost partition of the access ramp 3, and the other side rests on a combination of a raised side 6 and the access ramp as depicted in FIG. 1. The cover 5 may have a lip 14 along the lower edges of the cover which is configures to mate with the uppermost surfaces of the litter tray and access ramp upon which the cover will preferably sit. The cover 5 may also have a handle 15 on the top configured to be grasped by the used to remove the cover from the litter box assembly 1 in the event of cleaning, maintenance, or other need to access the components of the litter box.

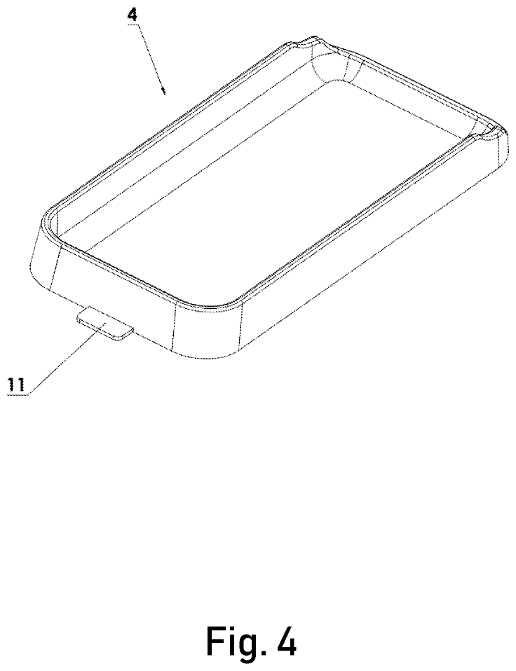

The cover 5 shall have an opening 12 in the side which is preferably sized such that its width is the same as the width of the access ramp 3 and placed such that it is located directly adjacent to and above the access ramp 3. The cover may also have a divider 13 which extends downward from the top portion of the cover. The divider 13 is preferable sized and located such that it extends from the top of the cover down to the raised side 6 of the litter tray 2 and the adjacent partition 7 of the access ramp. The divider 13 is also preferably dimensioned such that it extends horizontally from the side wall of the cover and inward along the raised side of the litter tray and adjacent partition of the access ramp. The divider is preferably configured such that the litter tray is substantially separated from the access ramp aside from a void where the divider does not extend. The preferred configuration is shown in FIGS. 1, 4 and 6. In such a configuration, a cat using the box would be forced to travel up the access ramp 3 and enter the litter tray via the void created where the divider is not placed. A cat exiting the box would travel the reverse route and exit down the access ramp wherein any residual litter stuck to the cat's feet would fall through the perforations 8 and land in the catch tray 4.

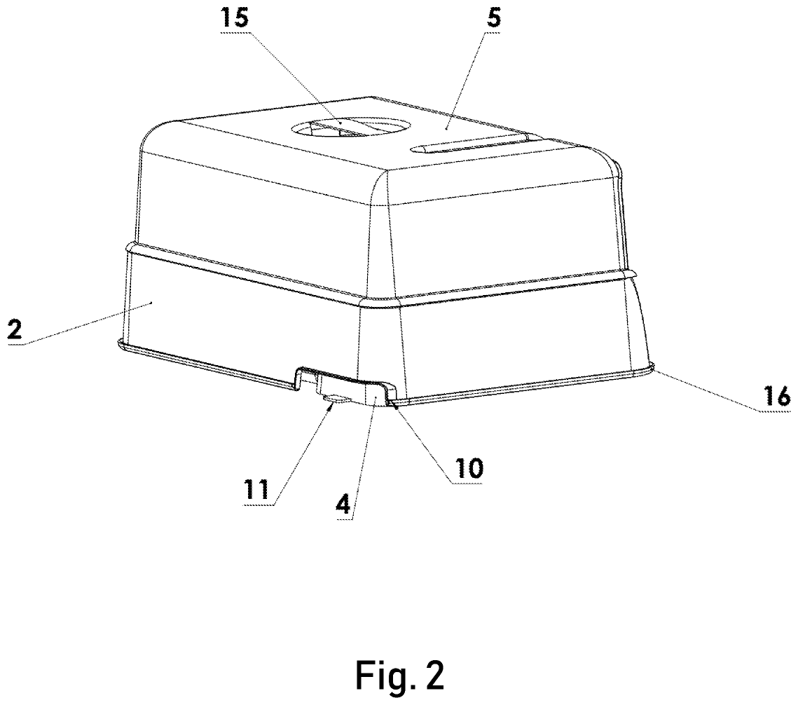

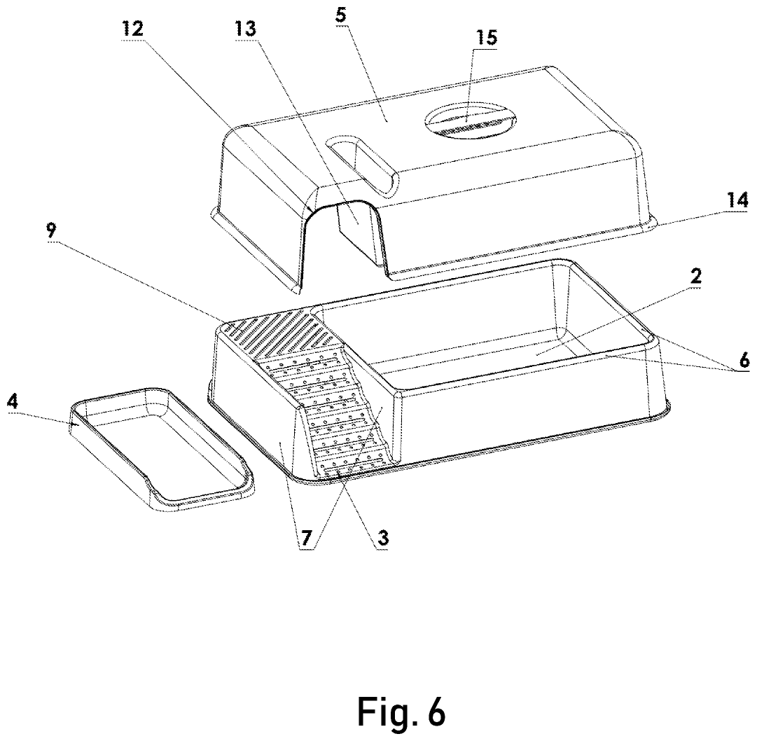

The litter box assembly may also have a lower pan 16. The lower pan 16 is preferably sized and shaped to correspond with that of the combined litter tray 2 and access ramp 3 as depicted in FIGS. 1 and 6. The lower pan 16 is preferably adjacent to and beneath the litter tray 2, access ramp 3, and catch tray 4 as depicted in FIGS. 1 and 2.

What is claimed is:

1. A litter box assembly comprising: a generally concave litter tray having raised sides;
An access ramp located proximate the litter tray having:
one or more partitions located on either side of the access ramp,
an upper platform adjacent to one of the raised sides of the litter tray
a surface of the access ramp with perforations,
a tray opening configured to allow the insertion of a catch tray under the access ramp;
A catch tray which is generally concave and configured to be placed underneath the access ramp;
A cover sized to correspond with the external dimensions of a combination of the litter tray and access ramp and configured to be placed on the litter tray and access ramp having:
an opening in the side of the cover located above the access ramp,
a divider which extends downward from the top of the cover and sized such that it meets the partition of the access ramp; and
A lower pan sized to correspond with the external dimensions of a combination of the litter tray and access ramp and configured to be placed beneath the litter tray and access ramp.

2. The litter box assembly of claim 1 where the catch tray further comprises a tab located on one end of the tray.

3. The litter box assembly of claim 1 where the cover further comprises a lip configured to mate with the upper surfaces of the litter tray and access ramp.

4. The litter box assembly of claim 1 where the cover further comprises a handle.
